(19) United States
(12) Patent Application Publication
(10) Pub. No.: US 2026/0274056 A1
(43) Pub. Date: Sep. 17, 2026

(54) BATTERY CARRIER FOR VEHICLE AND MOUNTING METHOD THEREOF

(71) Applicants: Hyundai Motor Company, Seoul (KR); Kia Corporation, Seoul (KR)

(72) Inventor: Jong Min Kim, Hwaseong-si (KR)

(21) Appl. No.: 19/261,472

(22) Filed: Jul. 7, 2025

(30) Foreign Application Priority Data
Mar. 17, 2025 (KR) 10-2025-0033955

(51) Int. Cl. B60K 1/04; B60L 50/60

(52) U.S. Cl. CPC B60K 1/04; B60L 50/66; B60K 2001/0405

(57) ABSTRACT

In certain examples, an apparatus includes a battery carrier for a vehicle supporting a battery. The battery carrier may include a bracket supporting both edges of the battery; a roof frame coupled to an upper portion of the bracket; and a stopper inserted into the bracket to prevent escape of the battery in a horizontal direction.

### CROSS-REFERENCE TO RELATED APPLICATIONS

This application claims benefit of priority to Korean Patent Application No. 10-2025-0033955 filed on Mar. 17, 2025 in the Korean Intellectual Property Office, the disclosure of which is incorporated herein by reference in its entirety.

### TECHNICAL FIELD

The present disclosure relates to a battery carrier for a vehicle and a mounting method thereof.

### BACKGROUND

Recently, as eco-friendly vehicles have rapidly become prevalent, technological development of large electric vehicles including electric buses has been actively conducted. Electric buses not emitting exhaust gases may reduce environmental pollution, and have advantages, such as reduced fuel costs and maintenance costs, so the introduction of electric buses has expanded.

Traditional diesel vehicles are operated by driving an engine upon receiving fuel stored in a fuel tank. Meanwhile, electric buses are driven using electric motors and high-voltage batteries instead of engines and fuel tanks. Accordingly, designing the space for installing batteries in vehicles efficiently has become an important technical challenge. In particular, since high-voltage batteries are large in weight and occupy a certain volume, a structure of stably fixing high-voltage batteries to the vehicle body, while optimizing the weight balance of the vehicle, is required.

Accordingly, technological development that may improve safety by optimizing a battery installation structure is required.

### SUMMARY

An aspect of the present disclosure is to provide a battery carrier for a vehicle advantageous in weight reduction and a mounting method thereof.

Another aspect of the present disclosure is to provide a battery carrier for a vehicle with improved structural rigidity and a mounting method thereof.

According to an aspect of the present disclosure, a battery carrier for a vehicle supporting a battery includes: a bracket supporting both edges of the battery; a roof frame coupled to an upper portion of the bracket; and a stopper inserted into the bracket to prevent escape of the battery in a horizontal direction.

According to another aspect of the present disclosure, a method of mounting a battery carry for a vehicle includes: a roof frame preparation operation of manufacturing a roof frame; a bracket coupling operation of coupling a bracket to both sides of the roof frame; a vehicle body coupling operation of coupling the bracket to a vehicle body; a battery insertion operation of slidably inserting a battery into the bracket; and a battery fixing operation of fixing the battery by inserting a fastening unit and a stopper into the roof frame.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 is a perspective view of a battery carrier for a vehicle according to an embodiment of the present disclosure;

FIG. 2 is an exploded view of a battery carrier for a vehicle according to an embodiment of the present disclosure;

FIG. 3 is a front view of a battery carrier for a vehicle according to an embodiment of the present disclosure;

FIG. 4 is a side view of a battery carrier for a vehicle according to an embodiment of the present disclosure;

FIG. 5 is a cross-sectional view taken along line A-A′ of FIG. 1;

FIG. 6 is a flowchart of a method of mounting a battery carrier for a vehicle according to another embodiment of the present disclosure;

FIG. 7 is a perspective view of a roof frame according to an embodiment of the present disclosure;

FIG. 8 is a perspective view illustrating a bracket coupled to a roof frame according to an embodiment of the present disclosure;

FIG. 9 is a perspective view illustrating a bracket coupled to a vehicle body according to an embodiment of the present disclosure;

FIG. 10 is a perspective view illustrating a configuration for inserting a battery into a bracket according to an embodiment of the present disclosure; and

FIG. 11 is a perspective view illustrating a configuration for coupling a stopper and a fastening unit according to an embodiment of the present disclosure.

### DETAILED DESCRIPTION OF ILLUSTRATIVE EMBODIMENTS

While the present disclosure may be modified in various ways and take on various alternative forms, specific embodiments thereof are shown in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms, such as “unit, part, portion, etc.” may be used to describe various components, but the components should not be limited by these terms. The above terms may refer to not only physically/visually distinct components, but also to functions or components of a portion even if the corresponding portion is not clearly divided.

The terms used herein to describe embodiments of the present disclosure is not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

In the description below, terms “front,” “rear,” “above,” “below,” “top,” “bottom,” etc. used in relation to directions are described based on the illustration in the drawing.

Embodiments of the present disclosure are described in detail with reference to the accompanying drawings.

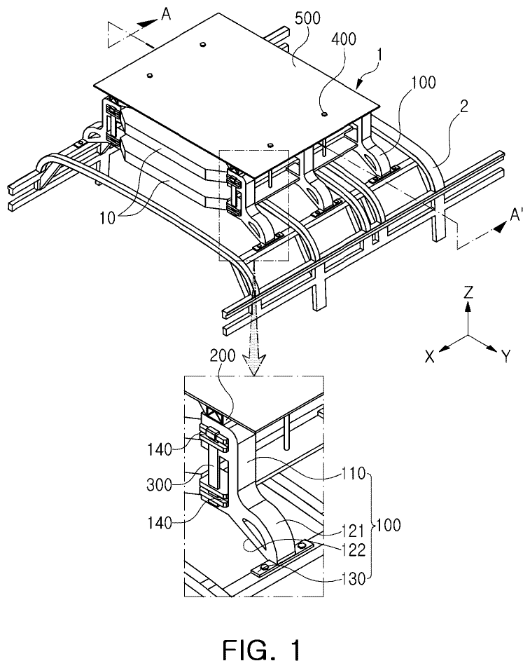

FIG. 1 is a perspective view of a battery carrier for a vehicle according to an embodiment of the present disclosure. Referring to FIG. 1, a battery carrier 1 for a vehicle according to an embodiment of the present disclosure may include a bracket 100, a roof frame 200, and a stopper 300.

The battery carrier 1 for a vehicle may be installed in an electric vehicle using electric energy as a power source. For example, the battery carrier 1 for a vehicle may be installed in an electric bus, an electric truck, etc. to fix a high-voltage battery. The vehicle to which the battery carrier 1 for a vehicle is coupled is not limited to the embodiment described above and may be coupled to various vehicles using a battery as a power source. The battery carrier 1 for a vehicle may be coupled to a vehicle body 2. For example, the battery carrier for a vehicle may be coupled to an upper portion of the vehicle body 2.

The bracket 100 may be provided to support the battery 10 and fix the battery carrier 1 for a vehicle to the vehicle body 2. The bracket 100 may be coupled to the vehicle body 2. For example, the bracket 100 may be coupled to the vehicle body 2 by screw fastening or welding using a separate coupling unit, such as a screw. Of course, it is also possible to couple the bracket 100 to the vehicle body 2 by using both a screw fastening method and a welding method. The bracket 100 may be provided on both sides of the battery 10 in a width direction. Here, when defining the terms for direction, the width direction may refer to the Y-axis direction in FIG. 1, a length direction may refer to the X-axis direction in FIG. 1, and a thickness direction may refer to the Z-axis direction in FIG. 1. The bracket 100 may be provided on, for example, one side and the other side of the battery 100 in the width direction. The bracket 100 may support the edges of both sides of the battery 10 in the width direction. A plurality of brackets 100 may be provided and spaced apart from each other in the length direction by a predetermined distance.

The roof frame 200 may be coupled to the bracket 100. For example, the roof frame 200 may be coupled to an upper portion of the bracket 100 to form an upper portion of the battery carrier 1 for a vehicle. The roof frame 200 may be screw-coupled or welded to the bracket 100 using a separate coupling unit, such as a screw, for example. Of course, it is also possible to couple the roof frame 200 to the bracket 100 using both the screw fastening method and the welding method. The roof frame 200 may be provided by coupling a plurality of square pipes, for example. The square pipes may be formed of a metal material. For example, the square pipes may be formed of aluminum, stainless steel, steel, etc. A cover panel 500 may be coupled to an upper portion of the roof frame 200. The cover panel 500 may be provided in a panel shape to cover the upper portion of the roof frame 200. The cover panel 500 may be fixed to the roof frame 200 by a fastening unit 400. The fastening unit 400 may fix the cover panel 500 to the roof frame 200 through the cover panel 500 and the roof frame 200.

The stopper 300 may be inserted into the bracket 100 to prevent the battery 10 from being separated from the bracket 100. For example, the stopper 300 may prevent the battery 10 from sliding in the length direction and being separated from the bracket 100. The stopper 300 may be provided on both sides of the battery 10 in the width direction. The stopper 300 may be inserted into the bracket 100 arranged at the outermost portions on both sides in the length direction. For example, the stopper 300 may be provided on the brackets 100 disposed on both sides in the length direction among the brackets 100 disposed on one side of the battery 10 in the width direction and on the brackets 100 disposed on both sides in the length direction among the brackets 100 disposed on the other side of the battery 10 in the width direction.

The battery carrier 1 for a vehicle according to an embodiment of the present disclosure may further include at least one fastening unit 400. The fastening unit 400 may be inserted into the edges of the roof frame 200 and the battery 10 to more firmly fix the battery 10. The fastening unit 400 may be provided on both sides of the roof frame 200 in the width direction. When a plurality of fastening units 400 are provided, the plurality of fastening units 400 may be provided to be spaced apart from each other by a predetermined distance in the length direction. The fastening unit 400 may be inserted into both sides of the battery 10 in the width direction through the roof frame 200. To this end, insertion holes into which the fastening unit 400 is inserted may be provided on both sides of the roof frame 200 in the width direction and both sides of the battery 10 in the width direction.

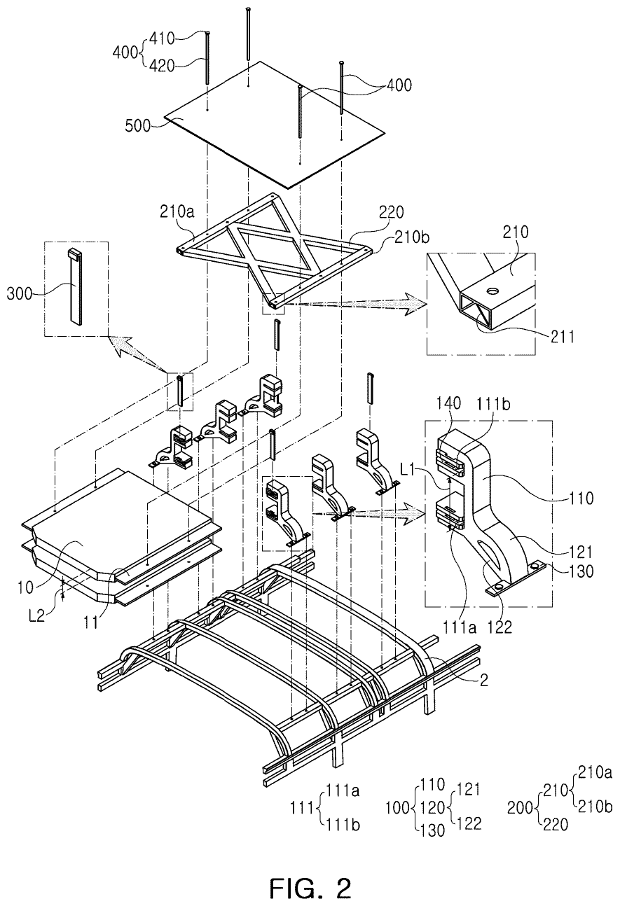

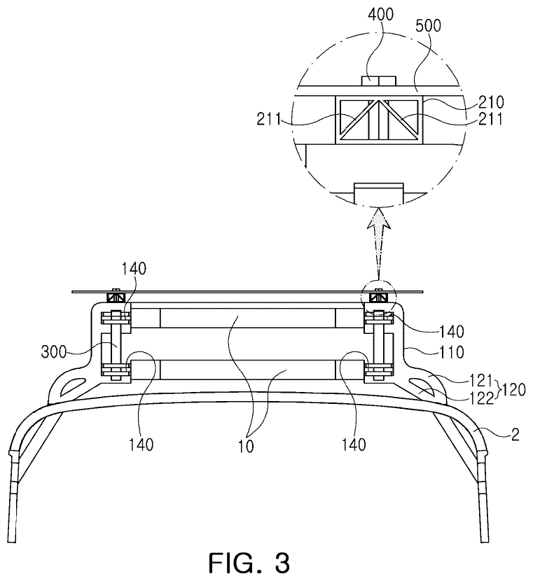

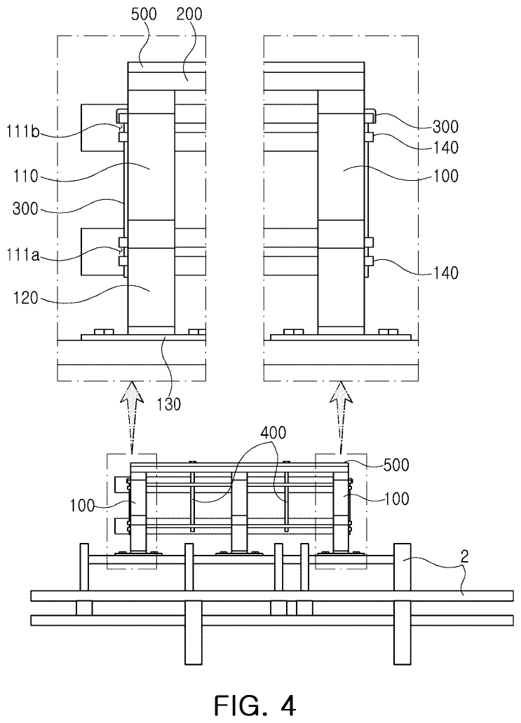

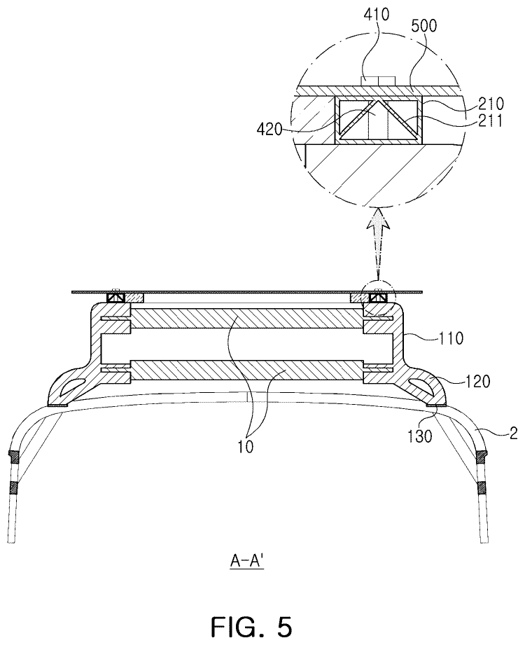

FIG. 2 is an exploded view of a battery carrier for a vehicle according to an embodiment of the present disclosure, FIG. 3 is a front view of a battery carrier for a vehicle according to an embodiment of the present disclosure, FIG. 4 is a side view of a battery carrier for a vehicle according to an embodiment of the present disclosure, and FIG. 5 is a cross-sectional view taken along line A-A′ of FIG. 1

Referring to FIGS. 2 to 5, the bracket 100 may be coupled to the vehicle body 2. The bracket 100 may be provided on both sides of the vehicle body 2 in the width direction. The bracket 100 may be formed of, for example, a metal material. The bracket 100 may be provided in plural. For example, a plurality of brackets 100 may be provided on both sides of the vehicle body 20 in the width direction and spaced apart from each other by a predetermined distance in the length direction. The brackets 100 provided on both sides in the width direction may be arranged in the length direction, and the battery 10 may be inserted between the brackets 100 facing each other in the width direction. The brackets 100 may support both sides of the battery 10 in the width direction. The numbers of brackets 100 provided on both sides of the battery 10 in the width direction may be the same or different. That is, the same number of brackets 10 may be provided on both sides of the battery 10 in the width direction, or a different number of brackets 10 may be provided on both sides of the battery 10 in the width direction. The position and number of the provided brackets 10 may be changed as long as the brackets 10 may support both sides of the battery 10 in the width direction to stably support the battery 10.

The bracket 100 may include, for example, a battery insertion part 110, a bridge part 120, and a flange part 130. The battery insertion part 110, the bridge part 120, and the flange part 130 may be provided integrally. That is, the battery insertion part 110, the bridge part 120, and the flange part 130 may refer to separate regions of a single member. However, the battery insertion part 110, the bridge part 120, and the flange part 130 may be manufactured as separate members and then coupled together. In addition, at least two members may be manufactured as a single member and then coupled to the other member.

The battery insertion part 110 may contact the battery 10 and support the battery 10. The battery insertion part 110 may include at least one battery insertion slit 111 into which the edge of the battery 10 is inserted. When the battery 10 is inserted into the battery carrier 1 for a vehicle, the edges on both sides of the battery 10 in the width direction may be inserted into battery insertion slit 111. A plurality of battery insertion slits 111 may be provided and spaced apart from each other by a predetermined distance in the thickness direction of the battery insertion part 110. The number of battery insertion slits 111 may be adjusted to correspond to the number of batteries 10 inserted into the battery carrier 1 for a vehicle. For example, when two batteries 10 are inserted into the battery carrier 1 for a vehicle, the battery insertion slits 111 may include a first battery insertion slit 111a provided in a lower portion of the battery insertion part 110 in the thickness direction and a second battery insertion slit 111b provided in an upper portion of the battery insertion part 110 in the thickness direction. Here, a distance L1 between the first battery insertion slit 111a and the second battery insertion slit 111b in the thickness direction may be provided to be greater than a thickness L2 of the battery 10 to prevent interference between the batteries 10 being inserted.

One side of the bridge part 120 may be connected to the battery insertion part 110. The other side of the bridge part 120 may protrude outwardly from the battery insertion part 110 in the width direction. A width-direction length of the battery carrier 1 for a vehicle may be extended by the bridge part 120, and accordingly, the battery carrier 1 for a vehicle may be more stably fixed to the vehicle body 2. The bridge part 120 may protrude outwardly in the width direction and then be bent downwardly in the thickness direction. The bridge part 120 may include, for example, a curved part 121 provided to be curved from an end portion of the battery insertion part 110 toward an installation target surface, that is, the vehicle body 2, and a reinforcing part 122 extending from an end portion of the battery insertion part 110 toward a curved end portion of the curved part. The curved part 121 may be provided in an overall inverted ‘L’ shape, for example. The reinforcing part 122 may be provided in an overall straight shape. Ends on both sides of the curved part 121 and the reinforcing part 122 may be connected to each other.

The flange part 130 may be connected to the other side of the bridge part 120. The flange part 130 may extend from an end portion of the bridge part 120 in the horizontal direction. The flange part 130 may be provided in a flat plate shape, parallel to the X-Y plane (in FIG. 1). For example, the flange part 130 may be provided to extend from a lower end portion of the bridge part 120 in the thickness direction to both sides in the length direction. However, the flange part 130 may be changed to a shape corresponding to the shape of the installation target surface. In other words, a bottom surface of the flange part 130 may be provided to be in close contact with the installation target surface. The flange part 130 may be fixed to the installation target surface, that is, the vehicle body 2. The flange part 130 may be fixed to the vehicle body 2 by at least one of welding and screw fastening, for example.

A plurality of brackets 100 may be provided on one side and the other side of the battery 10 in the width direction and spaced apart from each other by a predetermined distance in the length direction. A stopper insertion portion 140 may be provided in the brackets 100 arranged on both sides of the battery 10 in the length direction among the plurality of brackets 100. For example, the stopper insertion portion 140 may be provided in the bracket 100 disposed in one outer portion in the length direction and the bracket 100 disposed in the other outer portion in the length direction among the plurality of brackets 100 arranged on one side in the width direction. In addition, the stopper insertion portion 140 may be provided in the bracket 100 disposed in one outer portion in the length direction and the bracket 100 disposed in the other outer portion in the length direction among the plurality of brackets 100 arranged on the other side in the width direction. The stopper insertion portion 140 may be provided in the battery insertion part 110. For example, the stopper insertion portion 140 may be provided to protrude from an outer surface of the battery insertion part 110 in the length direction. A hole for inserting the stopper 300 may be formed in the stopper insertion portion 140.

The stopper 300 may be inserted into the stopper insertion portion 140. When the stopper 300 is inserted into the stopper insertion portion 140, at least a portion of the stopper 300 may be provided to face the battery insertion slit 111 in the length direction. The stopper 300 may be inserted into the bracket 100 to prevent the battery 10 from escaping. For example, the stopper 300 may prevent the battery 10 from sliding in the length direction and escaping from the bracket 100.

When the battery 10 slides to be inserted into the bracket 100 and the stopper 300 is inserted into the stopper insertion portion 140, both end portions of the battery 10 in the width direction are caught by the stopper 300, so that a horizontal separation of the battery 10 may be prevented. For example, the stopper 300 may limit a length-direction movement of the battery 10. A width-direction movement and a thickness-direction movement of the battery 10 may be limited by the mechanical shape of the bracket 100. In other words, the width-direction movement of the battery 10 may be limited by the bracket 100 disposed oppositely in the width direction, and the thickness-direction movement may be limited by the battery insertion slit 111 on the width-direction edges of the battery 10.

The stopper 300 may be provided in a shape in which one end portion is bent. When the stopper 300 is inserted into the stopper insertion portion 140, one end portion of the stopper 300 may be caught in the stopper insertion portion 140, so that the stopper 300 may not escape from the stopper insertion portion 140. For example, a thickness-direction upper end portion of the stopper 300 may be bent, and when the stopper 300 is inserted into the stopper insertion portion 140, the thickness-direction upper end portion of the stopper 300 may be caught in the second battery insertion slit 111b, so that the stopper 300 may not fall and may be disposed in the stopper insertion portion 140. It is also possible to use screws, welding, or other fastening members to secure the stopper 300 more strongly than the bracket 100.

The roof frame 200 may be coupled to an upper portion of the bracket 100. The roof frame 200 may include, for example, a roof side frame 210 and a roof inner frame 220. The roof side frame 210 may be a frame structure forming both sides of the roof frame 200 in the width direction. The roof side frame 210 may be provided as a pair. The pair of roof side frames 200 may be provided to be spaced apart from each other in the width direction. For example, the roof side frame 210 may include a first roof side frame 210a provided on one side in the width direction and a second roof side frame 210b provided on the other side in the width direction. The first roof side frame 210a and the second roof side frame 210b may be provided in the length direction. The first roof side frame 210a and the second roof side frame 210b may be provided in parallel. The first roof side frame 210a and the second roof side frame 210b may be connected to a plurality of brackets 100 arranged in the length direction on the lower side, respectively. The first roof side frame 210a and the second roof side frame 210b may be connected to the brackets 100 by at least one of screw fastening and welding. The roof side frame 210 may be provided as a beam member. For example, the roof side frame may be provided as a metal beam member having a hollow formed on the inner side. A reinforcing rib 211 connecting an upper inner surface and an inner surface of the beam member may be provided on the inner side of the beam member. The reinforcing rib 211 may strengthen the rigidity of the roof side frame 210.

The roof inner frame 220 may be provided between a pair of roof side frames 210 to connect the pair of roof side frames 210. For example, the roof inner frame 220 may connect the first roof side frame 210a and the second roof side frame 210b in the width direction. The roof inner frame 220 may be provided as a truss structure, for example.

The fastening unit 400 may penetrate through the edges of the roof side frame 210 and the battery 10. The fastening unit 400 may restrict the horizontal movement of the battery 10. The fastening unit 400 may include, for example, a head part 410 and a body part 420. The head part 410 may be seated in an upper portion of the roof side frame 210. Meanwhile, the battery carrier 1 for a vehicle according to an embodiment of the present disclosure may optionally include the cover panel 500 coupled to an upper portion of the roof frame 200. When the cover panel 500 is provided, the fastening unit 400 may penetrate through all the edges of the cover panel 500, the roof side frame 210, and the battery 10, thereby fixing the cover panel 500 to the roof frame 200. When the cover panel 500 is provided, the head part 410 of the fastening unit 400 may be seated on an upper surface of the cover panel 500. The body part 420 may extend from the head part 410. For example, the body part 420 may extend from a bottom surface of the head part 410. The body part 420 may penetrate through the edges of the roof side frame 210 and the battery 10. The fastening unit 400 may be provided in plural, and the plurality of fastening units 400 may be spaced apart from each other by a predetermined distance in the length direction of the roof side frame 210. The fastening unit 400 may be provided as a screw, for example. When the fastening unit 400 is provided as a screw, the fastening unit 400 may be screw-coupled to the edges of the roof side frame 210 and the battery 10.

According to an embodiment of the present disclosure, the battery carrier 1 for a vehicle uses the bracket 100 instead of a plurality of square tubes or frame structures used to support the related art batteries, thereby having an advantageous effect of a weight reduction. By forming the reinforcing rib 211 on the inner side of a roof side frame 210 and providing the roof inner frame 220 as a truss structure, structural rigidity may be improved.

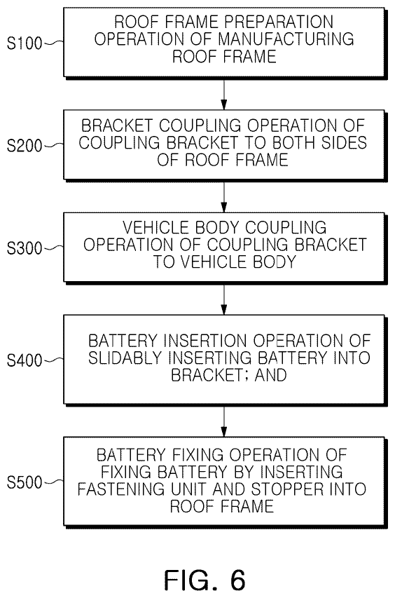

Hereinafter, a method of mounting a battery carrier for a vehicle according to another embodiment of the present disclosure will be described with reference to FIGS. 6 to 11.

FIG. 6 is a flowchart of a method of mounting a battery carrier for a vehicle according to another embodiment of the present disclosure. Referring to FIG. 6, the method of mounting a battery carrier for a vehicle may include a roof frame preparation operation (S100), a bracket coupling operation (S200), a vehicle body coupling operation (S300), a battery insertion operation (S400), and a battery fixing operation (S500).

Referring to FIG. 7, the roof frame 200 may be manufactured in the roof frame preparation operation (S100). The roof frame 200 may include the roof side frame 210 and the roof inner frame 220. The roof side frame 210 and the roof inner frame 220 may be formed of a metal material. For example, the roof side frame 210 may be provided as a beam member or a square pipe having a hollow portion. The reinforcing rib 211 for reinforcing rigidity may be provided inside the roof side frame 210. The reinforcing rib 211 may be provided in a shape connecting the upper inner surface of the roof side frame 210 and the inner surfaces on both sides in the width direction. The roof inner frame 220 may be provided as a truss structure. The roof side frame 210 may be coupled to both sides of the roof inner frame 220 in the width direction. The roof side frame 210 and the roof inner frame 220 may be coupled by at least one of welding and screw fastening.

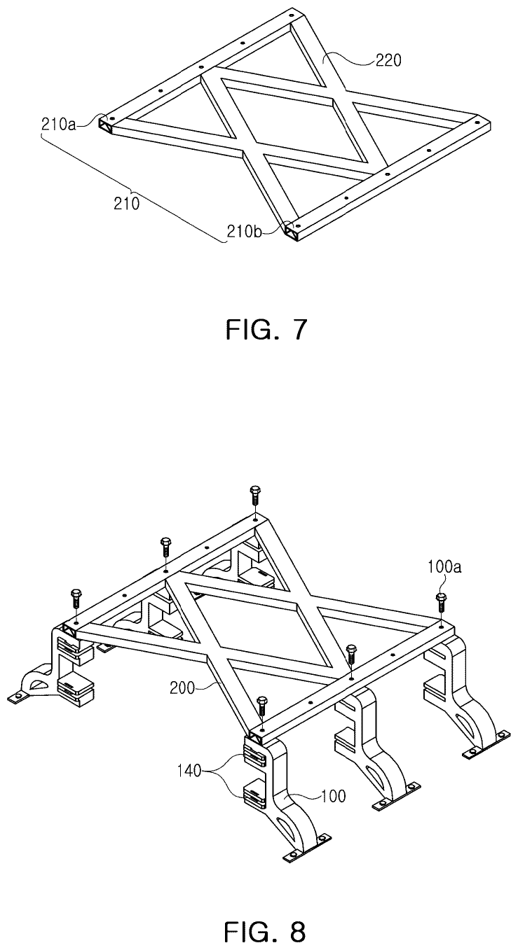

Referring to FIG. 8, the bracket coupling operation (S200) may be performed after the roof frame preparation operation (S100). In the bracket coupling operation (S200), a plurality of brackets 100 may be coupled to the roof frame 200. For example, the bracket 100 may be coupled to the roof side frame 210 of the roof frame 200. A plurality of brackets 100 may be provided to be spaced apart from each other by a predetermined distance in the length direction of the roof side frame 210. Here, the stopper insertion portion 140 may be provided in the brackets 100 arranged on both sides of the roof side frame 210 in the length direction. The bracket 100 may be coupled to the roof side frame 210 using a separate fastening member 100a, such as a screw. However, it is also possible to weld the bracket 100 to the roof side frame 210 or to use both welding and screw fastening. The bracket 100 may be provided in a portion in which the roof side frame 210 and the roof inner frame 220 meet. This may improve the structural rigidity of the battery carrier 1 for a vehicle.

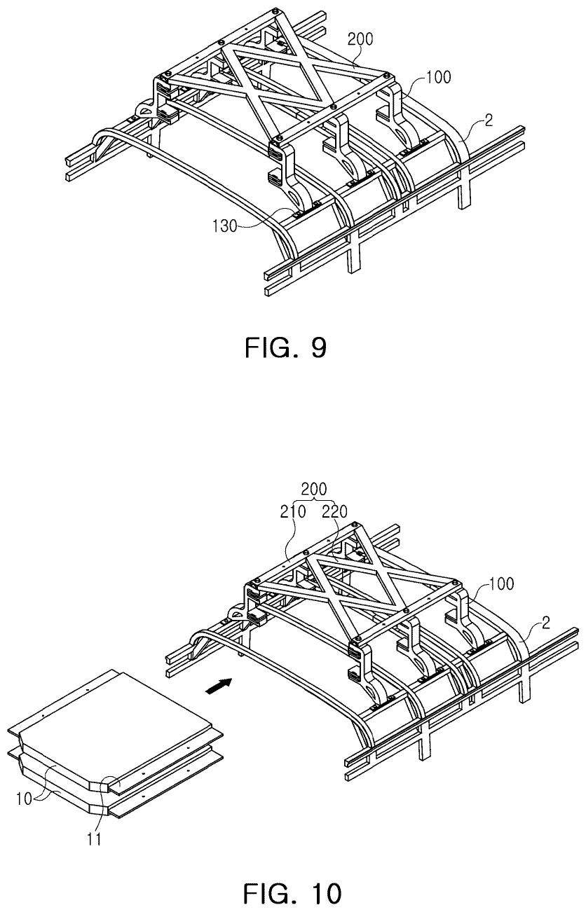

Referring to FIG. 9, a vehicle body coupling operation (S300) may be performed after the bracket coupling operation (S200). In the vehicle body coupling operation (S300), the bracket 100 may be coupled to the vehicle body 2. For example, the bracket 100 may be coupled to an upper portion of the vehicle body 2. The bracket 100 may include, for example, the battery insertion part 110, the bridge part 120, and the flange part 130. The battery insertion part 110, the bridge part 120, and the flange part 130 may be provided integrally. The flange part 130 of the bracket 100 may be coupled to the vehicle body 2. The flange part 130 may be coupled to the vehicle body 2 by at least one of screw fastening and welding.

Referring to FIG. 10, the battery insertion operation (S400) may be performed after the vehicle body coupling operation (S300). In the battery insertion operation (S400), the battery 10 may be inserted into the battery insertion slit 211 of the bracket 100. For example, the battery 10 may be provided with the battery flange 11 on both sides in the width direction, and after the battery flange 11 is horizontally disposed in the battery insertion slit 211, the battery 10 may be moved in parallel in the direction in which the bracket 100 is provided, so that the battery 10 may be inserted into the bracket 100.

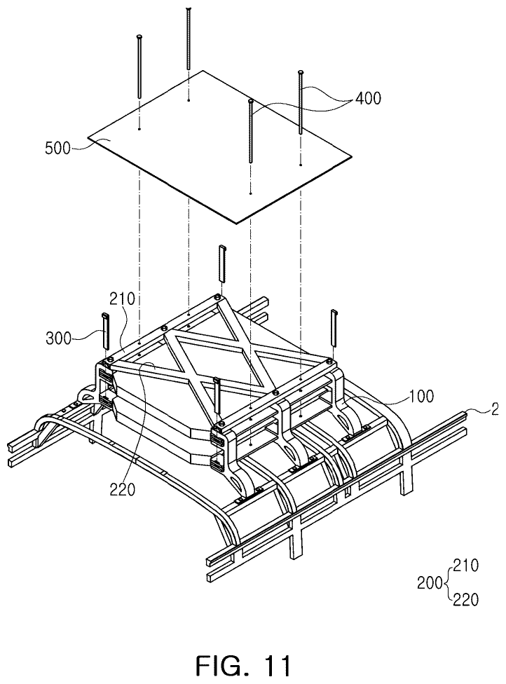

Referring to FIG. 11, when the battery 10 is inserted into the bracket 100, the battery fixing operation (S500) may be performed. In the battery fixing operation (S500), the stopper 300 may be inserted into the bracket 100. The stopper 300 may be inserted into the bracket 100 disposed on both sides in the length direction. The stopper 300 may overlap the battery flange 11 in the length direction. The stopper 300 may restrict a horizontal movement of the battery 10. In addition, in the battery fixing operation (S500), the fastening unit 400 may be inserted into the roof frame 200 and the battery 10. For example, the fastening unit 400 may be inserted into the roof side frame 210 and the battery flange 11. A plurality of fastening units 400 may be provided to be spaced apart from each other by a predetermined distance in the length direction of the roof side frame 210. The fastening unit 400 may be provided as a screw, for example. When the fastening unit 400 is provided as a screw, the fastening unit 400 may be screw-coupled to the edges of the roof side frame 210 and the battery 10. Meanwhile, in the battery fixing operation (S500), the cover panel 500 may be coupled to an upper portion of the roof frame 200. The cover panel 500 may be provided in a panel shape and may cover the upper portion of the roof frame 200. The cover panel 500 may be fixed to the roof frame 200 by the fastening unit 400. In other words, the fastening unit 400 may penetrate through the cover panel 500, the roof frame 200, and the battery 10 to fix the cover panel 500 to the roof frame 200. A component for coupling the cover panel 500 may be omitted.

The battery carrier for a vehicle according to embodiments of the present disclosure has an advantageous effect of a weight reduction. In addition, the battery carrier for a vehicle according to embodiments of the present disclosure has improved structural rigidity and thus has the effect of stably supporting the battery.

While embodiments have been shown and described above, it will be apparent to those skilled in the art that modifications and variations could be made without departing from the scope of the present disclosure as defined by the append portioned claims.

What is claimed is:

1. A battery carrier for a vehicle supporting a battery, the battery carrier comprising:
a bracket supporting both edges of the battery;
a roof frame coupled to an upper portion of the bracket; and
a stopper inserted into the bracket to prevent escape of the battery in a horizontal direction.

2. The battery carrier of claim 1, wherein the bracket includes:
a battery insertion part including a battery insertion slit into which an edge of the battery is inserted;
a bridge part having a first side connected to the battery insertion part; and
a flange part connected to a second side of the bridge part and fixed to an installation target surface.

3. The battery carrier of claim 2, wherein a plurality of battery insertion slits are provided, and the plurality of battery insertion slits are spaced apart from each other by a predetermined distance in a thickness direction of the battery insertion part.

4. The battery carrier of claim 2, wherein:
the battery insertion slit is one of a plurality of battery insertion slits,
the plurality of battery insertion slits comprises:
a first battery insertion slit provided in a lower portion of the battery insertion part in a thickness direction; and
a second battery insertion slit provided in an upper portion of the battery insertion part in the thickness direction, and
a distance in the thickness direction between the first battery insertion slit and the second battery insertion slit is greater than a thickness of the battery.

5. The battery carrier of claim 2, wherein:
a plurality of brackets are provided,
the plurality of brackets are provided on a first battery side and a second battery side of the battery in a width direction and spaced apart from each other by a predetermined distance in a length direction of the battery, and
the brackets disposed on both sides of the battery in the length direction among the plurality of brackets are provided with a stopper insertion portion.

6. The battery carrier of claim 5, wherein the stopper insertion portion is provided to protrude from an outer surface of the battery insertion part in the length direction.

7. The battery carrier of claim 6, wherein, when the stopper is inserted into the stopper insertion portion, at least a portion of the stopper is provided to face the battery insertion slit in the length direction.

8. The battery carrier of claim 1, wherein the roof frame includes:
a pair of roof side frames coupled to the bracket; and
a roof inner frame provided between the pair of roof side frames and connecting the pair of roof side frames.

9. The battery carrier of claim 8, wherein the roof inner frame is provided as a truss structure.

10. The battery carrier of claim 8, wherein:
the roof side frame is provided as a beam member including a hollow, and
a reinforcing rib connecting an upper inner surface and an inner surface of the beam member is provided on an inner side of the beam member.

11. The battery carrier of claim 8, further comprising a fastening unit penetrating through edges of the roof side frame and the battery.

12. The battery carrier of claim 11, wherein the fastening unit includes:
a head part seated on an upper portion of the roof side frame; and
a body part extending from the head part and penetrating through an edge of the battery.

13. The battery carrier of claim 1, further comprising a cover panel coupled to an upper portion of the roof frame.

14. A method of mounting a battery carrier for a vehicle, the method comprising:
a roof frame preparation operation of manufacturing a roof frame;
a bracket coupling operation of coupling a bracket to both sides of the roof frame;
a vehicle body coupling operation of coupling the bracket to a vehicle body;
a battery insertion operation of slidably inserting a battery into the bracket; and
a battery fixing operation of fixing the battery by inserting a fastening unit and a stopper into the roof frame.

15. The method of claim 14, further comprising:
a cover panel coupling operation of coupling a cover panel to an upper portion of the roof frame,
wherein the cover panel coupling operation is performed before the battery fixing operation.

16. The method of claim 15, wherein, in the battery fixing operation, the fastening unit penetrates through all of the cover panel, the roof frame, and the battery.

17. A battery carrier for a vehicle, the battery carrier comprising:
a plurality of brackets configured to support a battery of the vehicle, wherein each of the plurality of brackets comprises a stopper insertion portion;
a roof frame coupled to each of the plurality of brackets; and
a plurality of stoppers, each inserted into a respective stopper insertion portion of the plurality of brackets.

18. The battery carrier of claim 17, wherein each bracket of the plurality of brackets comprises:
a battery insertion part comprising a battery insertion slit;
a bridge part coupled to the battery insertion part; and
a flange part coupled to the bridge part.

19. The battery carrier of claim 17, wherein the plurality of brackets comprises:
a first set of brackets disposed on a first side of the battery in a width direction of the battery and spaced apart by a predetermined distance in a length direction of the battery; and
a second set of brackets disposed on a second side of the battery in the width direction of the battery and spaced apart by the predetermined distance in the length direction of the battery.

20. The battery carrier of claim 17, wherein the roof frame comprises:
a first roof side frame coupled to a first portion of the plurality of brackets;
a second roof side frame coupled to a second portion of the plurality of brackets; and
a roof inner frame connecting the first roof side frame and the second roof side frame.
